(19) United States
(12) Patent Application Publication
(10) Pub. No.: US 2026/0278539 A1
(43) Pub. Date: Sep. 17, 2026

(54) INFORMATION PROCESSING METHOD, INFORMATION PROCESSING DEVICE, AND NON-TRANSITORY COMPUTER READABLE RECORDING MEDIUM STORING INFORMATION PROCESSING PROGRAM

(71) Applicant: PANASONIC INTELLECTUAL PROPERTY MANAGEMENT CO., LTD., Osaka (JP)

(72) Inventor: Ryosuke NAGUMO, Tokyo (JP)

(21) Appl. No.: 19/676,169

(22) Filed: May 13, 2026

Related U.S. Application Data
(63) Continuation of application No. PCT/JP2024/037455, filed on Oct. 21, 2024.

(30) Foreign Application Priority Data
Nov. 20, 2023 (JP) 2023-196925

(51) Int. Cl. G06Q 10/087

(52) U.S. Cl. CPC G06Q 10/08726

(57) ABSTRACT

An information processing device calculates, based on an actual inventory quantity, an actual remaining order quantity, a maximum inventory quantity, a maximum remaining order quantity, a predicted sales quantity, a predicted upper limit sales quantity, and a predicted lower limit sales quantity, a predicted inventory quantity of a predetermined product satisfying a constraint condition that a predicted remaining order quantity does not exceed the maximum remaining order quantity in a case where the predicted sales quantity reaches the predicted upper limit sales quantity, and a predicted inventory quantity does not exceed the maximum inventory quantity in a case where the predicted sales quantity reaches the predicted lower limit sales quantity, calculates a predicted production quantity of the predetermined product based on the actual inventory quantity, the predicted sales quantity, and the predicted inventory quantity, and outputs the predicted production quantity for each unit period.

### FIELD OF INVENTION

The present disclosure relates to a technique for calculating a predicted production quantity of a predetermined product for each unit period and outputting the predicted production quantity for each unit period.

### BACKGROUND ART

Conventionally, a Production, Sales, Inventory (PSI) tool is used in an ordering operation of a company. The PSI tool predicts a future sales quantity of a product, determines an appropriate inventory quantity, and determines a production quantity or an order quantity to realize the predicted sales quantity and the determined inventory quantity.

For example, an order support apparatus disclosed in Patent Literature 1 includes a demand prediction processing unit that performs demand prediction from production/sales/inventory (PSI) data, an inventory diagnosis processing unit that determines shortage and excess inventory of an item from the PSI data, and a visualization processing unit that calculates future inventory data based on the PSI data and a demand prediction result by the demand prediction processing unit, and graphically displays a future inventory status on a time axis of a graph defined by the time axis and an inventory quantity together with future production/sales data.

Further, for example, an inventory replenishment system illustrated in Patent Literature 2 includes a storage device that stores information on a production capacity for producing a plurality of items, information on a minimum lot size, a unit lot size, and a maximum lot size of an inventory replenishment quantity for each item, information on an inventory reference quantity, a maximum inventory quantity, and a cumulative replenishment quantity for each item, and information on a current effective inventory quantity for each item, and a processing device that calculates an inventory replenishment quantity for each item based on various types of information stored in the storage device.

Further, for example, a production status visualization system illustrated in Patent Literature 3 creates production process model information that makes it possible to know a required element article, the number of required element articles, and a destination of an obtained article for each of a plurality of processes, sets, for a plurality of processes, the smaller one of a producible number indicating a maximum number of articles that can be produced in the processes and a planned production number as a scheduled production number based on the number of element articles, and determines the sum of the scheduled production number and the inventory number as an output number.

However, in the conventional techniques described above, an optimal inventory quantity is not determined by using a predicted sales quantity while considering the constraints of a production site, and a predicted production quantity is not automatically determined by using a predicted inventory quantity, so further improvement has been required.

Patent Literature 1: JP 2021-174452 A

Patent Literature 2: JP 4624191 B2

Patent Literature 3: JP 2022-113032 A

### SUMMARY OF THE INVENTION

The present disclosure has been made to solve the above problem, and an object of the present disclosure is to provide a technique capable of determining an optimal predicted inventory quantity by using a predicted sales quantity while considering constraints of a production site, and capable of automatically determining a predicted production quantity by using the predicted inventory quantity.

An information processing method according to the present disclosure is an information processing method executed by a computer, the method including: acquiring an actual production quantity, an actual sales quantity, an actual inventory quantity, and an actual remaining order quantity for each past unit period of a predetermined product; acquiring a maximum inventory quantity and a maximum remaining order quantity in a unit period of the predetermined product; calculating, based on the actual sales quantity, a predicted sales quantity, a predicted upper limit sales quantity allowed in a case where a sales quantity exceeds the predicted sales quantity, and a predicted lower limit sales quantity allowed in a case where the sales quantity falls below the predicted sales quantity, for each future unit period of the predetermined product; calculating, based on the actual inventory quantity, the actual remaining order quantity, the maximum inventory quantity, the maximum remaining order quantity, the predicted sales quantity, the predicted upper limit sales quantity, and the predicted lower limit sales quantity, a predicted inventory quantity for each future unit period of the predetermined product satisfying a constraint condition that a predicted remaining order quantity does not exceed the maximum remaining order quantity in a case where the predicted sales quantity reaches the predicted upper limit sales quantity, and a predicted inventory quantity does not exceed the maximum inventory quantity in a case where the predicted sales quantity reaches the predicted lower limit sales quantity; calculating a predicted production quantity for each future unit period of the predetermined product based on the actual inventory quantity, the predicted sales quantity, and the predicted inventory quantity; and outputting the predicted production quantity for each unit period.

According to the present disclosure, an optimal predicted inventory quantity can be determined using a predicted sales quantity while constraints of a production site are considered, and a predicted production quantity can be automatically determined using the predicted inventory quantity.

### BRIEF DESCRIPTION OF THE DRAWINGS

FIG. 1 is a diagram illustrating a configuration of a production support system according to the present embodiment.

FIG. 2 is a diagram illustrating an example of PSI data in the present embodiment.

FIG. 3 is a diagram illustrating an example of setting data in the present embodiment.

FIG. 4 is a flowchart for describing prediction processing by an information processing device according to an embodiment of the present disclosure.

FIG. 5 is a schematic diagram for describing calculation of a predicted inventory quantity by a predicted inventory quantity calculation unit of the present embodiment in more detail.

FIG. 6 is a diagram illustrating an example of a predicted sales quantity, a predicted upper limit sales quantity, a predicted lower limit sales quantity, a predicted inventory quantity, and a predicted production quantity for each unit period displayed on a display unit in the present embodiment.

FIG. 7 is a diagram illustrating an example of a user interface screen displayed on the display unit in the present embodiment.

FIG. 8 is a diagram illustrating an example of a user interface screen including a predicted sales quantity, a predicted inventory quantity, and a predicted production quantity for each unit period displayed on the display unit in the present embodiment.

### DETAILED DESCRIPTION

### Finding Underlying Present Disclosure

Each of the above-described conventional techniques has a problem, and does not automate a work process at a production site while simultaneously considering all elements.

Patent Literature 1 described above predicts a future production quantity, sales quantity, and inventory quantity up to several months ahead, diagnoses the future inventory from the predicted future production quantity, sales quantity, and inventory quantity, and automatically determines an order date and an order quantity from a diagnosis result. However, Patent Literature 1 does not consider constraints of a production site such as a maximum inventory quantity and a maximum remaining order quantity in a unit period.

Further, since the above Patent Literature 2 does not calculate an inventory replenishment quantity by using a predicted sales quantity, it is not clear whether an inventory quantity can be further reduced from a current inventory reference quantity.

Further, in Patent Literature 3 described above, a producible number rectangular area is only highlighted in a case where a producible number is smaller than a planned production number, and the planned production number is not automatically calculated according to constraints.

To solve the above problem, a technique below is disclosed.

(1) An information processing method according to one aspect of the present disclosure is an information processing method executed by a computer, the method including: acquiring an actual production quantity, an actual sales quantity, an actual inventory quantity, and an actual remaining order quantity for each past unit period of a predetermined product; acquiring a maximum inventory quantity and a maximum remaining order quantity in a unit period of the predetermined product; calculating, based on the actual sales quantity, a predicted sales quantity, a predicted upper limit sales quantity allowed in a case where a sales quantity exceeds the predicted sales quantity, and a predicted lower limit sales quantity allowed in a case where the sales quantity falls below the predicted sales quantity, for each future unit period of the predetermined product; calculating, based on the actual inventory quantity, the actual remaining order quantity, the maximum inventory quantity, the maximum remaining order quantity, the predicted sales quantity, the predicted upper limit sales quantity, and the predicted lower limit sales quantity, a predicted inventory quantity for each future unit period of the predetermined product satisfying a constraint condition that a predicted remaining order quantity does not exceed the maximum remaining order quantity in a case where the predicted sales quantity reaches the predicted upper limit sales quantity, and a predicted inventory quantity does not exceed the maximum inventory quantity in a case where the predicted sales quantity reaches the predicted lower limit sales quantity; calculating a predicted production quantity for each future unit period of the predetermined product based on the actual inventory quantity, the predicted sales quantity, and the predicted inventory quantity; and outputting the predicted production quantity for each unit period.

According to this configuration, based on an actual sales quantity for each past unit period of a predetermined product, a predicted sales quantity, a predicted upper limit sales quantity allowable in a case where a sales quantity exceeds the predicted sales quantity, and a predicted lower limit sales quantity allowable in a case where a sales quantity falls below the predicted sales quantity, for each future unit period of a predetermined product are calculated. Then, a predicted inventory quantity for each future unit period of a predetermined product satisfying a constraint condition that a predicted remaining order quantity does not exceed a maximum remaining order quantity in a case where a predicted sales quantity reaches a predicted upper limit sales quantity and a predicted inventory quantity does not exceed a maximum inventory quantity in a case where a predicted sales quantity reaches a predicted lower limit sales quantity is calculated. Then, a predicted production quantity for each future unit period of the predetermined product is calculated based on the actual inventory quantity, the predicted sales quantity, and the predicted inventory quantity.

Therefore, an optimal predicted inventory quantity can be determined using a predicted sales quantity while constraints of a production site are considered, and a predicted production quantity can be automatically determined using the predicted inventory quantity.

(2) In the information processing method according to (1) above, the outputting may include outputting the predicted sales quantity, the predicted upper limit sales quantity, the predicted lower limit sales quantity, the predicted inventory quantity, and the predicted production quantity for each unit period.

According to this configuration, a predicted sales quantity, a predicted upper limit sales quantity, a predicted lower limit sales quantity, a predicted inventory quantity, and a predicted production quantity for each unit period are output to the display unit, so that the predicted sales quantity, the predicted upper limit sales quantity, the predicted lower limit sales quantity, the predicted inventory quantity, and the predicted production quantity for each unit period can be presented to the user.

(3) The information processing method according to (1) or (2) above may further include: acquiring a maximum production quantity in a unit period of the predetermined product; and increasing the predicted inventory quantity in a second unit period which is before a first unit period in a case where the predicted sales quantity in the first unit period exceeds the maximum production quantity.

According to this configuration, even if a predicted sales quantity in the first unit period exceeds a maximum production quantity, inventory increased in advance in the second unit period before the first unit period can be allocated to sales.

(4) In the information processing method according to any one of (1) to (3) above, calculating the predicted sales quantity, the predicted upper limit sales quantity, and the predicted lower limit sales quantity may include calculating the predicted sales quantity, the predicted upper limit sales quantity, and the predicted lower limit sales quantity by inputting the actual sales quantity to a prediction model created by pre-training, and acquiring the predicted sales quantity, the predicted upper limit sales quantity, and the predicted lower limit sales quantity output from the prediction model.

According to this configuration, a predicted sales quantity, a predicted upper limit sales quantity, and a predicted lower limit sales quantity can be easily calculated using the prediction model created by pre-training.

(5) The information processing method according to any one of (1) to (4) above may further include acquiring calendar information regarding past and future days of the week and holidays, weather information regarding past and future weather, and a past actual sales quantity of a similar product of the predetermined product, and calculating the predicted sales quantity, the predicted upper limit sales quantity, and the predicted lower limit sales quantity may include calculating the predicted sales quantity, the predicted upper limit sales quantity, and the predicted lower limit sales quantity based on the actual sales quantity of the predetermined product, the calendar information, the weather information, and the actual sales quantity of the similar product.

According to this configuration, a predicted sales quantity, a predicted upper limit sales quantity, and a predicted lower limit sales quantity are calculated using not only an actual sales quantity of a predetermined product but also calendar information regarding past and future days of the week and holidays, weather information regarding past and future weather, and a past actual sales quantity of a similar product of the predetermined product. Therefore, a predicted sales quantity, a predicted upper limit sales quantity, and a predicted lower limit sales quantity can be calculated with higher accuracy.

(6) In the information processing method according to any one of (1) to (5) above, calculating the predicted inventory quantity may include: calculating the predicted inventory quantity and the predicted remaining order quantity in a unit period t by using the actual inventory quantity and the actual remaining order quantity in a unit period t−1, the predicted sales quantity in the unit period t, and a variable production quantity in the unit period t; calculating a plurality of combinations of the predicted inventory quantity and the predicted remaining order quantity in the unit period t by changing the production quantity; selecting, from the plurality of combinations, a combination that satisfies the constraint condition and minimizes a sum of the predicted inventory quantity and the predicted remaining order quantity; and calculating the predicted inventory quantity of the selected combination as the predicted inventory quantity in the unit period t.

When a predicted sales quantity and a production quantity in the unit period t and an actual inventory quantity and an actual remaining order quantity in the unit period t−1 are obtained, a predicted inventory quantity can be calculated. Here, the production quantity in the unit period t is a variable, and a plurality of combinations of the predicted inventory quantity and the predicted remaining order quantity in the unit period t are calculated by changing the production quantity. Then, among the plurality of combinations, a combination that satisfies a constraint condition and minimizes a sum of the predicted inventory quantity and the predicted remaining order quantity is selected. Then, the predicted inventory quantity of the selected combination is calculated as the predicted inventory quantity in the unit period t.

Therefore, since a constraint condition is satisfied and a smallest predicted inventory quantity is calculated, the predicted inventory quantity can be optimized.

(7) In the information processing method according to any one of (1) to (6) above, calculating the predicted production quantity may include calculating the predicted production quantity by adding the predicted inventory quantity to the predicted sales quantity and subtracting the actual inventory quantity from the added quantity.

According to this configuration, a predicted inventory quantity is added to a predicted sales quantity, and an actual inventory quantity is subtracted from the added quantity, so that a predicted production quantity can be calculated.

(8) In the information processing method according to any one of (1) to (7) above, calculating the predicted inventory quantity may include calculating the predicted inventory quantity of each of a plurality of warehouses in a case where the predetermined product passes through the plurality of warehouses from when the predetermined product is produced to when the predetermined product is sold and moves among the plurality of warehouses for each unit period for which prediction is performed.

According to this configuration, even in a case where there is lead time from production to sales, a predicted inventory quantity and a predicted production quantity can be calculated in consideration of the lead time.

The present disclosure can be implemented not only as an information processing method for executing the characteristic processing as described above, but also as an information processing device or the like having a characteristic configuration corresponding to characteristic processing executed by the information processing method. Further, the present disclosure can also be implemented as a computer program that causes a computer to execute characteristic processing included in the information processing method described above. Therefore, an effect similar to the effect in the above information processing method can also be achieved by another aspect described below.

(9) An information processing device according to another aspect of the present disclosure includes: a first acquisition unit that acquires an actual production quantity, an actual sales quantity, an actual inventory quantity, and an actual remaining order quantity for each past unit period of a predetermined product; a second acquisition unit that acquires a maximum inventory quantity and a maximum remaining order quantity in a unit period of the predetermined product; a first calculation unit that calculates, based on the actual sales quantity, a predicted sales quantity, a predicted upper limit sales quantity allowed in a case where a sales quantity exceeds the predicted sales quantity, and a predicted lower limit sales quantity allowed in a case where the sales quantity falls below the predicted sales quantity, for each future unit period of the predetermined product; a second calculation unit that calculates, based on the actual inventory quantity, the actual remaining order quantity, the maximum inventory quantity, the maximum remaining order quantity, the predicted sales quantity, the predicted upper limit sales quantity, and the predicted lower limit sales quantity, a predicted inventory quantity for each future unit period of the predetermined product satisfying a constraint condition that a predicted remaining order quantity does not exceed the maximum remaining order quantity in a case where the predicted sales quantity reaches the predicted upper limit sales quantity, and a predicted inventory quantity does not exceed the maximum inventory quantity in a case where the predicted sales quantity reaches the predicted lower limit sales quantity; a third calculation unit that calculates a predicted production quantity for each future unit period of the predetermined product based on the actual inventory quantity, the predicted sales quantity, and the predicted inventory quantity; and an output unit that outputs the predicted production quantity for each unit period.

(10) An information processing program according to another aspect of the present disclosure causes a computer to function to: acquire an actual production quantity, an actual sales quantity, an actual inventory quantity, and an actual remaining order quantity for each past unit period of a predetermined product; acquire a maximum inventory quantity and a maximum remaining order quantity in a unit period of the predetermined product; calculate, based on the actual sales quantity, a predicted sales quantity, a predicted upper limit sales quantity allowed in a case where a sales quantity exceeds the predicted sales quantity, and a predicted lower limit sales quantity allowed in a case where the sales quantity falls below the predicted sales quantity, for each future unit period of the predetermined product; calculate, based on the actual inventory quantity, the actual remaining order quantity, the maximum inventory quantity, the maximum remaining order quantity, the predicted sales quantity, the predicted upper limit sales quantity, and the predicted lower limit sales quantity, a predicted inventory quantity for each future unit period of the predetermined product satisfying a constraint condition that a predicted remaining order quantity does not exceed the maximum remaining order quantity in a case where the predicted sales quantity reaches the predicted upper limit sales quantity, and a predicted inventory quantity does not exceed the maximum inventory quantity in a case where the predicted sales quantity reaches the predicted lower limit sales quantity; calculate a predicted production quantity for each future unit period of the predetermined product based on the actual inventory quantity, the predicted sales quantity, and the predicted inventory quantity; and output the predicted production quantity for each unit period.

(11) A non-transitory computer-readable recording medium according to another aspect of the present disclosure records an information processing program, and the information processing program causes a computer to function to: acquire an actual production quantity, an actual sales quantity, an actual inventory quantity, and an actual remaining order quantity for each past unit period of a predetermined product; acquire a maximum inventory quantity and a maximum remaining order quantity in a unit period of the predetermined product; calculate, based on the actual sales quantity, a predicted sales quantity, a predicted upper limit sales quantity allowed in a case where a sales quantity exceeds the predicted sales quantity, and a predicted lower limit sales quantity allowed in a case where the sales quantity falls below the predicted sales quantity, for each future unit period of the predetermined product; calculate, based on the actual inventory quantity, the actual remaining order quantity, the maximum inventory quantity, the maximum remaining order quantity, the predicted sales quantity, the predicted upper limit sales quantity, and the predicted lower limit sales quantity, a predicted inventory quantity for each future unit period of the predetermined product satisfying a constraint condition that a predicted remaining order quantity does not exceed the maximum remaining order quantity in a case where the predicted sales quantity reaches the predicted upper limit sales quantity, and a predicted inventory quantity does not exceed the maximum inventory quantity in a case where the predicted sales quantity reaches the predicted lower limit sales quantity; calculate a predicted production quantity for each future unit period of the predetermined product based on the actual inventory quantity, the predicted sales quantity, and the predicted inventory quantity, and output the predicted production quantity for each unit period.

Hereinafter, an embodiment of the present disclosure will be described with reference to the accompanying drawings. Note that each of the embodiments described below illustrates one specific example of the present disclosure. Numerical values, shapes, components, steps, orders of steps, and the like of the embodiments below are merely examples, and are not intended to limit the present disclosure. Further, a component not described in an independent claim representing a highest concept among components in the embodiments below is described as an optional component. Further, in all the embodiments, individual contents can be combined.

### Embodiment)

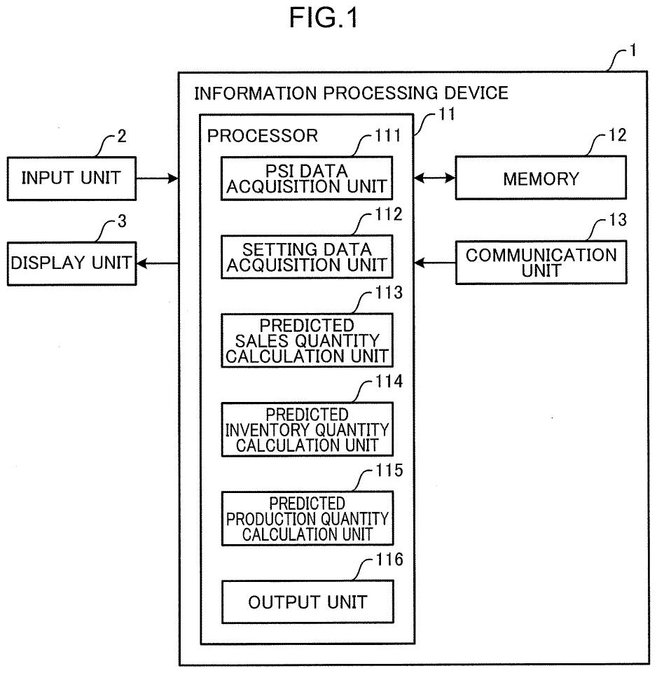

FIG. 1 is a diagram illustrating a configuration of a production support system according to the present embodiment.

The production support system illustrated in FIG. 1 includes an information processing device 1, an input unit 2, and a display unit 3.

The input unit 2 is, for example, a keyboard, a mouse, or a touch panel, and receives information input from a user. The input unit 2 is connected to the information processing device 1 communicably with each other in a wired or wireless manner. Note that the input unit 2 may be communicably connected to the information processing device 1 via a network. The network is a local area network or a wide area network.

The information processing device 1 includes a processor 11, a memory 12, and a communication unit 13. The information processing device 1 is, for example, a personal computer, a tablet computer, or a server.

The processor 11 is a central processing unit (CPU), for example. The processor 11 implements a PSI data acquisition unit 111, a setting data acquisition unit 112, a predicted sales quantity calculation unit 113, a predicted inventory quantity calculation unit 114, a predicted production quantity calculation unit 115, and an output unit 116.

The memory 12 is a storage device capable of storing various types of information, such as a random access memory (RAM), a hard disk drive (HDD), a solid state drive (SSD), or a flash memory. The memory 12 stores various types of information.

The memory 12 stores PSI data and setting data.

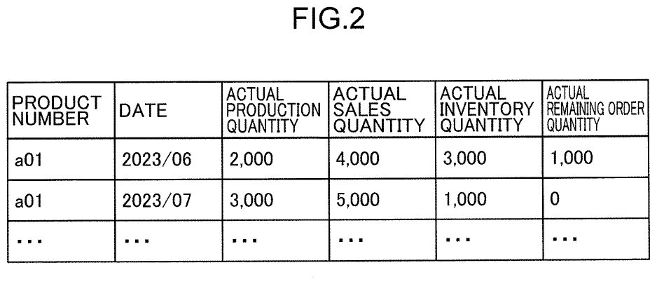

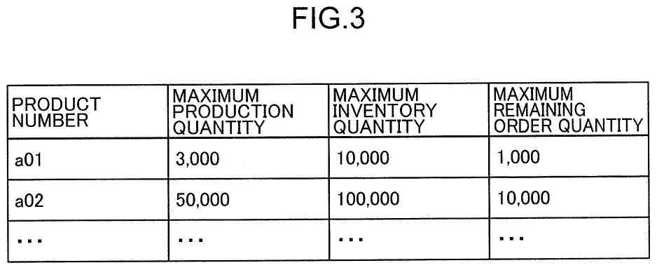

FIG. 2 is a diagram illustrating an example of PSI data in the present embodiment, and FIG. 3 is a diagram illustrating an example of setting data in the present embodiment.

The PSI data includes an actual production quantity, an actual sales quantity, an actual inventory quantity, and an actual remaining order quantity of a predetermined product per past unit period. As illustrated in FIG. 2, the memory 12 stores PSI data in which a product number for identifying a product, a date (year and month), an actual production quantity, an actual sales quantity, an actual inventory quantity, and an actual remaining order quantity are associated with each other. For example, FIG. 2 illustrates an actual production quantity, an actual sales quantity, an actual inventory quantity, and an actual remaining order quantity of a product with a product number “a 01” in June 2023 and July 2023. Note that, although a unit period in the present embodiment is one month, the present disclosure is not particularly limited to this, and may be one day, one week, or any period.

The actual production quantity represents a quantity of a predetermined product produced within a unit period. Note that in a case where a product is produced in a factory of another company, a production quantity is also referred to as an order quantity. The actual sales quantity represents a quantity of a predetermined product sold within a unit period. The actual inventory quantity represents a quantity of a predetermined product stored as inventory at a time point at which a unit period elapses. The actual remaining order quantity represents a quantity that has not been delivered at a time point at which a unit period elapses out of an order quantity of a predetermined product ordered within a unit period. Note that, for the reason that it is desired to secure a certain inventory quantity, even if there is inventory, a remaining order may occur.

Further, the memory 12 may store PSI data in which a product number for identifying a product and information for identifying a customer, a date, an actual production quantity, an actual sales quantity, an actual inventory quantity, and an actual remaining order quantity are associated with each other.

The setting data includes a maximum production quantity, a maximum inventory quantity, and a maximum remaining order quantity in a unit period of a predetermined product. As illustrated in FIG. 3, the memory 12 stores setting data in which a product number for identifying a product, a maximum production quantity in a unit period, a maximum inventory quantity in the unit period, and a maximum remaining order quantity in the unit period are associated with each other. For example, FIG. 3 illustrates a maximum production quantity, a maximum inventory quantity, and a maximum remaining order quantity in a unit period of a product with a product number “a01” and a product with a product number “a02”. Note that the unit period is the same period as that of the PSI data, and is, for example, one month.

The maximum production quantity represents a maximum quantity of a predetermined product that can be produced within a unit period. The maximum inventory quantity represents a maximum quantity of a predetermined product that can be stored as an inventory within a unit period. The maximum remaining order quantity represents a maximum quantity that is allowed even if a product cannot be delivered at a time point at which a unit period elapses out of an order quantity of a predetermined product ordered within a unit period.

The input unit 2 receives an input of PSI data by the user. The processor 11 of the information processing device 1 stores PSI data input by the input unit 2 in the memory 12. Further, the input unit 2 receives an input of setting data by the user. The processor 11 of the information processing device 1 stores setting data input by the input unit 2 in the memory 12.

Note that the information processing device 1 may receive PSI data or setting data from an external device such as a server, and store the received PSI data or setting data in the memory 12.

Further, the input unit 2 receives selection by the user of a product for which a production quantity, a sales quantity, an inventory quantity, and a remaining order quantity are predicted for each unit period. Further, the input unit 2 may receive selection by the user of a unit period, for example, one day, one week, one month, or the like, for which prediction is performed. Further, the input unit 2 may receive selection by the user of a period, for example, one week, one month, six months, or the like, for which prediction is performed.

The PSI data acquisition unit 111 acquires an actual production quantity, an actual sales quantity, an actual inventory quantity, and an actual remaining order quantity of a predetermined product for each past unit period. The PSI data acquisition unit 111 reads, from the memory 12, PSI data including an actual production quantity, an actual sales quantity, an actual inventory quantity, and an actual remaining order quantity of a predetermined product for each past unit period. For example, the PSI data acquisition unit 111 may read, from the memory 12, PSI data for each month of one year in the past. Further, in a case where the memory 12 stores PSI data for each day and a production quantity, a sales quantity, an inventory quantity, and a remaining order quantity for each month are predicted, the PSI data acquisition unit 111 may aggregate PSI data for each day to create PSI data for each month.

Further, the PSI data acquisition unit 111 may acquire a past actual sales quantity of a similar product of a predetermined product. The PSI data acquisition unit 111 may read a past actual sales quantity of a similar product from the memory 12.

The setting data acquisition unit 112 acquires a maximum production quantity, a maximum inventory quantity, and a maximum remaining order quantity in a unit period of a predetermined product. The setting data acquisition unit 112 reads, from the memory 12, setting data including a maximum production quantity, a maximum inventory quantity, and a maximum remaining order quantity in a unit period of a predetermined product.

The communication unit 13 acquires calendar information regarding past and future days of the week and holidays, and weather information regarding past and future weather. The communication unit 13 receives the calendar information and the weather information transmitted by an external server. The weather information includes, for example, weather for the past year and weather for one week in the future. The weather information may be used in a case where a predicted sales quantity is calculated on a daily basis or a weekly basis.

Based on an actual sales quantity of a predetermined product, calendar information, weather information, and an actual sales quantity of a similar product, the predicted sales quantity calculation unit 113 calculates a predicted sales quantity, a predicted upper limit sales quantity allowable in a case where a sales quantity exceeds the predicted sales quantity, and a predicted lower limit sales quantity allowable in a case where a sales quantity falls below the predicted sales quantity, for each future unit period of a predetermined product. For example, the predicted sales quantity calculation unit 113 calculates a predicted sales quantity, a predicted upper limit sales quantity, and a predicted lower limit sales quantity of a predetermined product for each month for 6 months in the future.

The predicted sales quantity calculation unit 113 inputs an actual sales quantity of a predetermined product, calendar information, weather information, and an actual sales quantity of a similar product to a prediction model created by pre-training, and acquires a predicted sales quantity, a predicted upper limit sales quantity, and a predicted lower limit sales quantity output from the prediction model to calculate a predicted sales quantity, a predicted upper limit sales quantity, and a predicted lower limit sales quantity.

The predicted sales quantity calculation unit 113 estimates a predicted sales quantity, a predicted upper limit sales quantity, and a predicted lower limit sales quantity by inputting acquired actual sales quantity of the predetermined product, calendar information, weather information, and actual sales quantity of a similar product to a trained prediction model obtained by machine learning a relationship between an actual sales quantity of the predetermined product, calendar information, weather information, and an actual sales quantity of the similar product and a sales quantity, an upper limit sales quantity, and a lower limit sales quantity.

Note that the prediction model is created by machine learning. Examples of the machine learning include supervised learning in which a relationship between an input and an output is learned using training data in which a label (output information) is assigned to input information, unsupervised learning in which a structure of data is constructed only from an unlabeled input, semi-supervised learning in which both labeled input and unlabeled input are handled, and reinforcement learning that learns, through trial and error, an action that maximizes a reward. Further, specific methods of machine learning include a neural network (including deep learning using a multilayer neural network), genetic programming, a decision tree, a Bayesian network, a support vector machine (SVM), and the like. In the machine learning of the present disclosure, any of the specific examples described above may be used.

The machine learning of the prediction model may be performed using an actual sales quantity for the past three months of a predetermined product, calendar information, weather information, and an actual sales quantity of a similar product as input values, and using a sales quantity, an upper limit sales quantity, and a lower limit sales quantity in the current month of the predetermined product as output values. Further, the prediction model may be subjected to machine learning by further using a predicted sales quantity calculated in the past. In this case, a difference between an actual sales quantity and a predicted sales quantity may be used as training data of an upper limit sales quantity and a lower limit sales quantity.

Further, the predicted sales quantity calculation unit 113 may calculate a predicted sales quantity, a predicted upper limit sales quantity, and a predicted lower limit sales quantity for each future unit period of a predetermined product based only on an actual sales quantity of the predetermined product. The predicted sales quantity calculation unit 113 may input an actual sales quantity of a predetermined product to a prediction model created by pre-training, and acquire a predicted sales quantity, a predicted upper limit sales quantity, and a predicted lower limit sales quantity output from the prediction model to calculate a predicted sales quantity, a predicted upper limit sales quantity, and a predicted lower limit sales quantity.

Further, the predicted sales quantity calculation unit 113 may calculate a predicted sales quantity, a predicted upper limit sales quantity, and a predicted lower limit sales quantity for each future unit period of a predetermined product based on an actual sales quantity of the predetermined product, and at least one of calendar information, weather information, and an actual sales quantity of a similar product. The predicted sales quantity calculation unit 113 may input an actual sales quantity of a predetermined product, and at least one of calendar information, weather information, and an actual sales quantity of a similar product to a prediction model created by pre-training, and acquire a predicted sales quantity, a predicted upper limit sales quantity, and a predicted lower limit sales quantity output from the prediction model to calculate a predicted sales quantity, a predicted upper limit sales quantity, and a predicted lower limit sales quantity.

The predicted inventory quantity calculation unit 114 calculates a predicted inventory quantity for each future unit period of a predetermined product satisfying a constraint condition that a predicted remaining order quantity does not exceed a maximum remaining order quantity in a case where a predicted sales quantity reaches a predicted upper limit sales quantity and a predicted inventory quantity does not exceed a maximum inventory quantity in a case where a predicted sales quantity reaches a predicted lower limit sales quantity based on an actual inventory quantity, an actual remaining order quantity, the maximum inventory quantity, the maximum remaining order quantity, the predicted sales quantity, a predicted upper limit sales quantity, and a predicted lower limit sales quantity. For example, the predicted inventory quantity calculation unit 114 calculates a predicted inventory quantity for each month for 6 months in the future of a predetermined product.

More specifically, the predicted inventory quantity calculation unit 114 calculates a predicted inventory quantity and a predicted remaining order quantity in a unit period t by using an actual inventory quantity and an actual remaining order quantity in the unit period t−1, a predicted sales quantity in the unit period t, and a variable production quantity in the unit period t. Next, the predicted inventory quantity calculation unit 114 calculates a plurality of combinations of a predicted inventory quantity and a predicted remaining order quantity in the unit period t by changing a production quantity. Next, the predicted inventory quantity calculation unit 114 selects a combination that satisfies a constraint condition and minimizes a sum of a predicted inventory quantity and a predicted remaining order quantity out of the plurality of combinations. Next, the predicted inventory quantity calculation unit 114 calculates a predicted inventory quantity in the selected combination as a predicted inventory quantity in the unit period t. Then, the predicted inventory quantity calculation unit 114 sequentially calculates predicted inventory quantities in the unit periods t+1, t+2, t+3, t+4, and t+5.

The predicted production quantity calculation unit 115 calculates a predicted production quantity for each future unit period of a predetermined product based on an actual inventory quantity, a predicted sales quantity, and a predicted inventory quantity. More specifically, the predicted production quantity calculation unit 115 calculates a predicted production quantity by adding a predicted inventory quantity to a predicted sales quantity and subtracting an actual inventory quantity from the added quantity.

The output unit 116 outputs a predicted sales quantity, a predicted upper limit sales quantity, a predicted lower limit sales quantity, a predicted inventory quantity, and a predicted production quantity for each unit period to the display unit 3. Note that the output unit 116 may output only a predicted production quantity for each unit period to the display unit 3.

The display unit 3 is, for example, a liquid crystal display device, and displays information output by the output unit 116. The display unit 3 is connected to the information processing device 1 communicably with each other in a wired or wireless manner. Note that the display unit 3 may be communicably connected to the information processing device 1 via a network. The network is a local area network or a wide area network.

The display unit 3 displays a predicted sales quantity, a predicted upper limit sales quantity, a predicted lower limit sales quantity, a predicted inventory quantity, and a predicted production quantity for each unit period. Note that the display unit 3 may display only a predicted production quantity for each unit period.

Next, prediction processing by the information processing device 1 according to an embodiment of the present disclosure will be described.

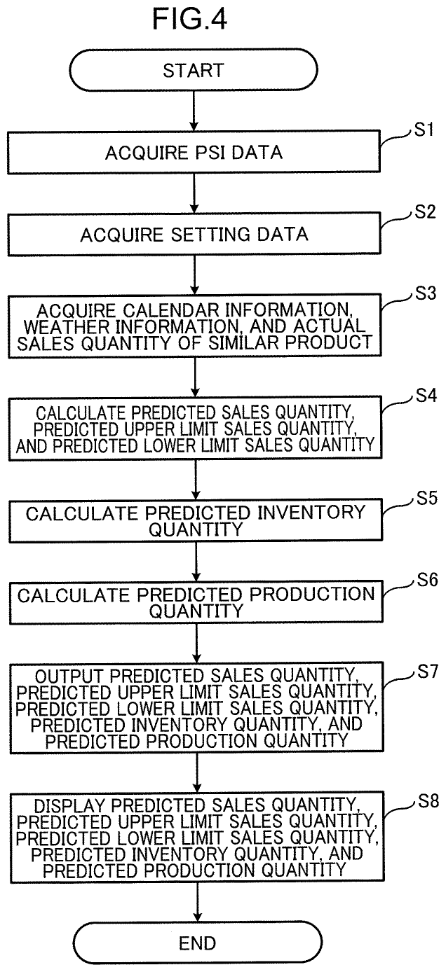

FIG. 4 is a flowchart for describing prediction processing by the information processing device 1 according to an embodiment of the present disclosure.

First, in Step S1, the PSI data acquisition unit 111 acquires PSI data including an actual production quantity, an actual sales quantity, an actual inventory quantity, and an actual remaining order quantity for each past unit period of a predetermined product. Note that the input unit 2 may receive in advance input, by the user, of information for identifying a product and information for identifying a unit period.

Next, in Step S2, the setting data acquisition unit 112 acquires setting data including a maximum production quantity, a maximum inventory quantity, and a maximum remaining order quantity in a unit period of the predetermined product. Note that the input unit 2 may receive in advance input, by the user, of a maximum production quantity, a maximum inventory quantity, and a maximum remaining order quantity.

Next, in Step S3, the communication unit 13 acquires calendar information regarding past and future days of the week and holidays and weather information regarding past and future weather, and the PSI data acquisition unit 111 acquires an actual sales quantity for each past unit period of a similar product of the predetermined product.

Next, in Step S4, the predicted sales quantity calculation unit 113 calculates a predicted sales quantity, a predicted upper limit sales quantity, and a predicted lower limit sales quantity for each future unit period of the predetermined product based on the actual sales quantity of the predetermined product, the calendar information, the weather information, and the actual sales quantity of the similar product. The predicted sales quantity calculation unit 113 inputs the actual sales quantity of the predetermined product, the calendar information, the weather information, and the actual sales quantity of the similar product to a prediction model created by pre-training, and acquires a predicted sales quantity, a predicted upper limit sales quantity, and a predicted lower limit sales quantity output from the prediction model.

Next, in Step S5, the predicted inventory quantity calculation unit 114 calculates a predicted inventory quantity for each future unit period of the predetermined product satisfying a constraint condition that a predicted remaining order quantity does not exceed a maximum remaining order quantity in a case where a predicted sales quantity reaches a predicted upper limit sales quantity and a predicted inventory quantity does not exceed a maximum inventory quantity in a case where a predicted sales quantity reaches a predicted lower limit sales quantity based on an actual inventory quantity, an actual remaining order quantity, the maximum inventory quantity, the maximum remaining order quantity, the predicted sales quantity, a predicted upper limit sales quantity, and a predicted lower limit sales quantity.

Here, calculation of an optimal predicted inventory quantity will be described in more detail.

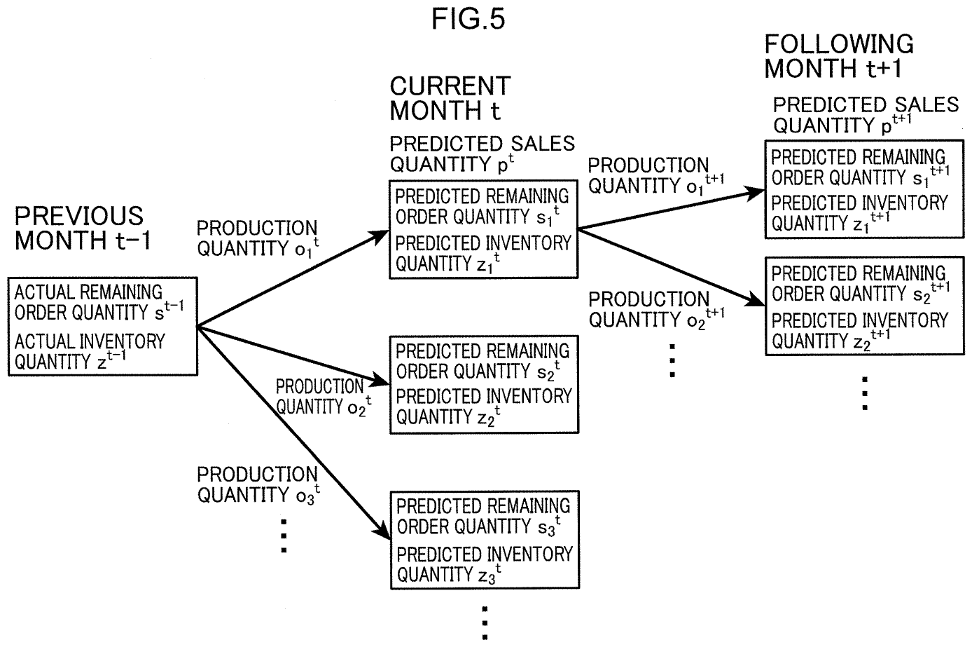

FIG. 5 is a schematic diagram for describing calculation of a predicted inventory quantity by the predicted inventory quantity calculation unit 114 of the present embodiment in more detail.

Note that, in FIG. 5, the unit period is one month. The predicted inventory quantity calculation unit 114 calculates a predicted inventory quantity in the future in and after the current month on the first day of the current month. Here, p^{t} represents a predicted sales quantity of a current month t, p^{t+1} represents a predicted sales quantity of the following month t+1, s^{t} represents a predicted remaining order quantity of the current month t, s^{t+1} represents a predicted remaining order quantity of the following month t+1, s^{t-1} represents an actual remaining order quantity of the previous month t−1, z^{t} represents a predicted inventory quantity of the current month t, z^{t+1} represents a predicted inventory quantity of the following month t+1, z^{t-1} represents an actual inventory quantity of the previous month t−1, o^{t} represents a production quantity of the current month t, and o^{t+1} represents a production quantity of the following month t+1.

An order quantity of the current month t is expressed by (p^{t}+s^{t-1}), and an actual quantity of the current month t is expressed by (o^{t}+z^{t-1}). A delivered quantity c^{t} of the current month t is restricted to the smaller one of an order quantity and an actual quantity of the current month t. For this reason, the delivered quantity c^{t} of the current month t is represented by min(p^{t}+s^{t-1}, o^{t}+z^{t-1}). By this, the predicted remaining order quantity s^{t} at the end of the current month becomes (p^{t}+s^{t-1})−c^{t}, and the predicted inventory quantity z^{t} at the end of the current month becomes (o^{t}+z^{t-1})−c^{t}.

In a case where a combination (s^{t-1}, z^{t-1}) of an actual remaining order quantity and an actual inventory quantity of the previous month t−1 is obtained and the predicted sales quantity p^{t} of the current month t is obtained, when the production quantity o^{t} is determined, a combination (s^{t}, z^{t}) of a predicted remaining order quantity and a predicted inventory quantity at the end of the current month is automatically determined.

Considering a combination of a remaining order quantity and an inventory quantity as one state, the state transitions according to a production quantity of each month.

The predicted inventory quantity calculation unit 114 enumerates options of a plurality of production quantities o₁^{t}, o₂^{t}, . . . that are equal to or less than a maximum production quantity, and calculates transitions (s₁^{t}, z₁^{t}), (s₂^{t}, z₂^{t}), . . . of the state of the current month t (combination of the predicted remaining order quantity and the predicted inventory quantity) for each of the plurality of production quantities o₁^{t}, o₂^{t}, . . . . Then, the predicted inventory quantity calculation unit 114 calculates a transition of the state (combination of the predicted remaining order quantity and the predicted inventory quantity) in and after the following month for each of the plurality of production quantities. By this, the predicted inventory quantity calculation unit 114 can calculate a transition of the state (combination of the predicted remaining order quantity and the predicted inventory quantity) on a monthly basis from the previous month to a period for which prediction is performed (for example, 6 months ahead).

The predicted inventory quantity calculation unit 114 calculates cost yᵢ^{t} of each state, and selects a state transition that minimizes a total value of cost of states of each month. The predicted inventory quantity calculation unit 114 calculates the cost yᵢ^{t} of each state based on the following Equation (1).

$${y}_{i}^{t} = f ( {o}_{i}^{t} \vert {p}^{t} + {σ}_{+}^{t} , {s}^{t - 1} , {z}^{t - 1} , {o}^{t - 1} ; {s}_{0} , {z}_{0} ) + f ( {o}_{i}^{t} \vert {p}^{t} - {σ}_{-}^{t} , {s}^{t - 1} , {z}^{t - 1} , {o}^{t - 1} ; {s}_{0} , {z}_{0} ) \qquad ( 1 )$$

In Equation (1) above, oᵢ^{t} is a variable, p^{t}=σ₊^{t}, s^{t-1}, z^{t-1}, and o^{t-1} are given variables, and s₀ and z₀ are constants. Here, oᵢ^{t} in which both a state i and the time t correspond to the cost yᵢ^{t} of each state is regarded as a variable. The given variable is a variable regarding the time t, but does not depend on the state i. The constant is a fixed value independent of both the state i and the time t.

Here, p^{t}+σ₊^{t} represents a predicted upper limit sales quantity, and p^{t}−σ₋^{t} represents a predicted lower limit sales quantity. The predicted inventory quantity calculation unit 114 selects cost at which the predicted remaining order quantity s^{t} does not exceed the maximum remaining order quantity s₀ even when the predicted sales quantity p^{t} reaches the predicted upper limit sales quantity p^{t}+σ₊^{t} at the certain production quantity o^{t}. Further, the predicted inventory quantity calculation unit 114 selects cost at which the predicted inventory quantity z^{t} does not exceed the maximum inventory quantity z₀ even when the predicted sales quantity p^{t} reaches the predicted lower limit sales quantity p^{t}−σ₋^{t} at the certain production quantity o^{t}.

Further, functions of the first term and the second term in Equation (1) above are expressed by an abstract function shown in Equation (2) below.

$$f ( o \vert p , s , z , {o}^{′} ; {s}_{0} , {z}_{0} ) = {α [ p + s - c - {s}_{0} ]}_{+} + {β [ o + z - c - {z}_{0} ]}_{+} + γ ( p + s - c ) + ω ( o + z - c ) + η ( o - {o}^{′} ) \qquad ( 2 )$$

In Equation (2), c is min(p+s, o+z), and the function [x]₊ means max(0, x). Further, in Equation (2), α, β, γ, ω, and η are coefficients. Here, α, β, γ, and ω satisfy a relationship of α, β>>γ, ω.

The predicted inventory quantity calculation unit 114 enumerates all states (combinations of the predicted remaining order quantity and the predicted inventory quantity) up to a predetermined period (for example, 6 months) ahead, and selects a transition of a state that minimizes a total value of cost from a plurality of states. As shown in Equation (2), since cost in a case where the predicted remaining order quantity s^{t} is greater than the maximum remaining order quantity s₀ is larger than cost in a case where the predicted remaining order quantity s^{t} is less than the maximum remaining order quantity s₀, a state in which the predicted remaining order quantity s^{t} is larger than the maximum remaining order quantity s₀ is not selected. Similarly, since cost in a case where the predicted inventory quantity z^{t} is greater than the maximum inventory quantity z₀ is greater than cost in a case where the predicted inventory quantity z^{t} is less than the maximum inventory quantity z₀, a state in which the predicted inventory quantity z^{t} is greater than the maximum inventory quantity z₀ is not selected.

Further, the remaining order quantity and the inventory quantity are preferably as small as possible. For this reason, a combination of the predicted remaining order quantity s^{t} and the predicted inventory quantity z^{t} in which a total value of the predicted remaining order quantity s^{t} and the predicted inventory quantity z^{t} is the smallest is selected.

Furthermore, a state (combination of the predicted remaining order quantity and the predicted inventory quantity) in which a monthly production quantity is the same is selected by considering variation of a production quantity (o^{t}−o^{t-1}).

The predicted inventory quantity calculation unit 114 calculates cost of a combination of the predicted remaining order quantity and the predicted inventory quantity for each of a plurality of production quantities in the unit period t based on Equation (2), and selects a combination of the predicted remaining order quantity and the predicted inventory quantity in which cost is the lowest. The predicted inventory quantity calculation unit 114 calculates a predicted inventory quantity of the selected combination as a predicted inventory quantity in the unit period t. Then, the predicted inventory quantity calculation unit 114 also calculates a predicted inventory quantity in and after the unit period t+1 by the same method as described above.

Note that in a case where a predicted sales quantity in a first unit period exceeds a maximum production quantity, the predicted inventory quantity calculation unit 114 may increase a predicted inventory quantity in a second unit period which is before the first unit period. In this case, the predicted inventory quantity calculation unit 114 may add a quantity obtained by subtracting the maximum production quantity from the predicted sales quantity in the first unit period to the predicted inventory quantity in the second unit period.

Further, the predicted inventory quantity calculation unit 114 may calculate a predicted inventory quantity of each of a plurality of warehouses in a case where a predetermined product passes through a plurality of warehouses from when the predetermined product is produced to when the predetermined product is sold and moves among a plurality of warehouses for each unit period for which prediction is performed. As described above, even in a case where there is lead time from production to sales, a predicted inventory quantity and a predicted production quantity can be calculated in consideration of the lead time.

Returning to FIG. 4, next, in Step S6, the predicted production quantity calculation unit 115 calculates a predicted production quantity for each future unit period of a predetermined product based on the actual inventory quantity, the predicted sales quantity, and the predicted inventory quantity. Here, the predicted production quantity calculation unit 115 calculates the predicted production quantity by adding the predicted inventory quantity to the predicted sales quantity and subtracting the actual inventory quantity from the added quantity.

Next, in Step S7, the output unit 116 outputs the predicted sales quantity, the predicted upper limit sales quantity, the predicted lower limit sales quantity, the predicted inventory quantity, and the predicted production quantity for each unit period to the display unit 3.

Next, in Step S8, the display unit 3 displays the predicted sales quantity, the predicted upper limit sales quantity, the predicted lower limit sales quantity, the predicted inventory quantity, and the predicted production quantity for each unit period.

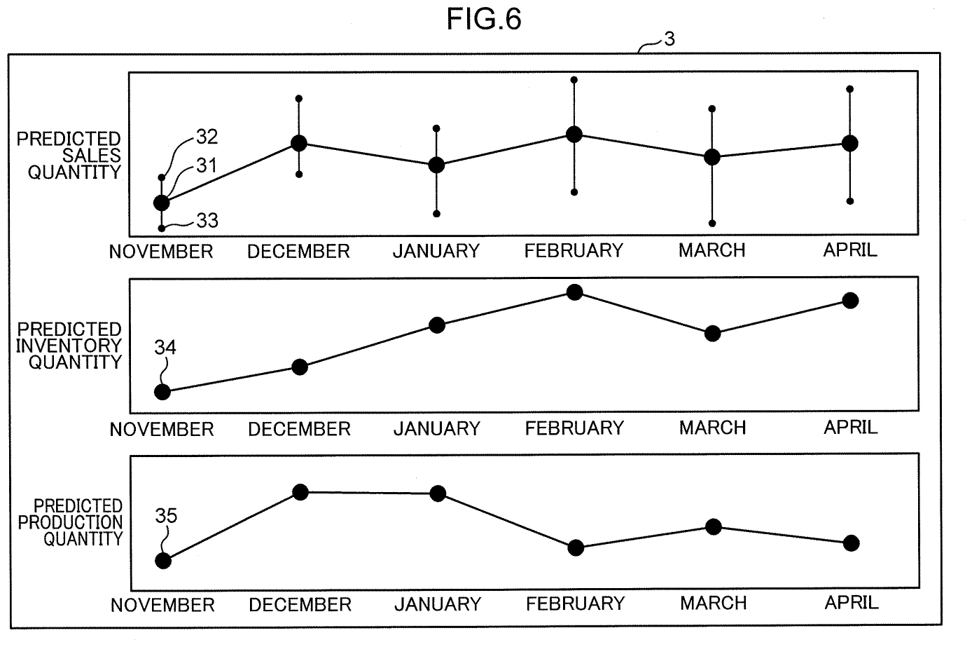

FIG. 6 is a diagram illustrating an example of a predicted sales quantity, a predicted upper limit sales quantity, a predicted lower limit sales quantity, a predicted inventory quantity, and a predicted production quantity for each unit period displayed on the display unit 3 in the present embodiment.

In FIG. 6, the display unit 3 displays, for each month, a predicted sales quantity 31, a predicted upper limit sales quantity 32, a predicted lower limit sales quantity 33, a predicted inventory quantity 34, and a predicted production quantity 35 for six months from November to April. Further, in each month, the predicted sales quantity 31 and the predicted upper limit sales quantity 32 are connected by a straight line, and the predicted sales quantity 31 and the predicted lower limit sales quantity 33 are connected by a straight line. By this, the user can recognize how far the predicted upper limit sales quantity 32 and the predicted lower limit sales quantity 33 are apart from the predicted sales quantity 31.

Note that, in the present embodiment, a predicted sales quantity, a predicted upper limit sales quantity, a predicted lower limit sales quantity, a predicted inventory quantity, and a predicted production quantity for each unit period are displayed, but the present disclosure is not particularly limited to this, and the configuration may be such that only a predicted production quantity is displayed.

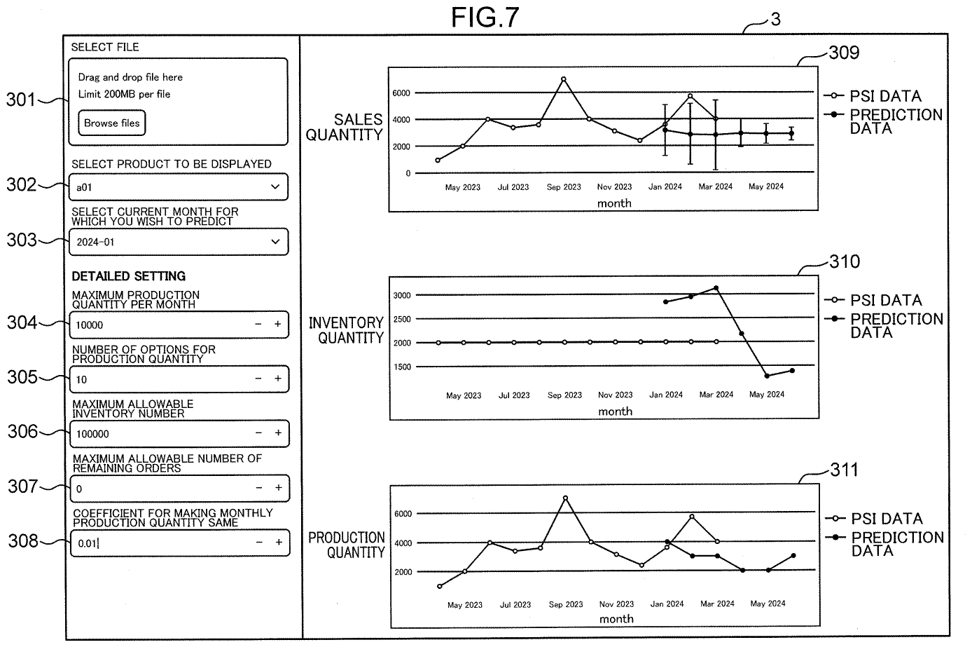

FIG. 7 is a diagram illustrating an example of a user interface screen displayed on the display unit 3 in the present embodiment. Although only a prediction result is displayed on the display screen illustrated in FIG. 6, a prediction result is displayed and input of data by the user is received on the user interface screen illustrated in FIG. 7.

The user interface screen illustrated in FIG. 7 includes a PSI data input area 301, a product selection area 302, a prediction period selection area 303, a maximum production quantity input area 304, a production quantity option count input area 305, a maximum inventory quantity input area 306, a maximum remaining order quantity input area 307, a coefficient input area 308, a sales quantity display area 309, an inventory quantity display area 310, and a production quantity display area 311.

The PSI data input area 301 receives input of past PSI data by the user. The user drags and drops a file storing past PSI data into the PSI data input area 301. By this, past PSI data used for prediction is input. Note that the user may select a file storing past PSI data from a plurality of files.

The product selection area 302 displays a drop-down list indicating a plurality of selectable product names, and receives selection, by the user, of a product name of a product for which prediction is performed. The user selects a desired product name from a drop-down list displayed in the product selection area 302.

The prediction period selection area 303 displays a drop-down list from which a year and a month in which prediction is started can be selected, and receives selection, by the user, of a year and a month in which prediction is started. The user selects a year and a month in which prediction is started from a drop-down list displayed in the prediction period selection area 303. When a year and a month in which prediction is started are selected, prediction results for six months from the selected year and month are displayed.

The maximum production quantity input area 304 receives input, by the user, of a maximum production quantity for one month. A minimum unit of a production quantity is determined in advance for each product. For this reason, products are produced, for example, in units of 100, 1000, or 10,000. The user presses a plus button or a minus button displayed in the maximum production quantity input area 304 to input a maximum production quantity for one month.

The production quantity option count input area 305 receives input, by the user, of the number of options of a production quantity to be enumerated when a predicted inventory quantity is calculated. An option of a production quantity is used when a plurality of combinations of a predicted remaining order quantity and a predicted inventory quantity for each unit period are calculated. When the number of options is large, prediction accuracy of a predicted remaining order quantity and a predicted inventory quantity is improved, but time required for calculation processing becomes long. On the other hand, when the number of options is small, prediction accuracy of a predicted remaining order quantity and a predicted inventory quantity decreases, but time required for calculation processing is shortened. For example, in a case where the number of options of a production quantity input by the user is 10 and a maximum production quantity is 10,000, 0, 1000, 2000, 3000, . . . , and 10,000 are used as options of a production quantity (11 options including 0).

The maximum inventory quantity input area 306 receives input, by the user, of a maximum inventory quantity for one month.

The maximum remaining order quantity input area 307 receives input, by the user, of a maximum remaining order quantity for one month.

The coefficient input area 308 receives input, by the user, of a coefficient for making a monthly production quantity the same. The input coefficient is the coefficient η in Equation (2) above, and is multiplied by a difference obtained by subtracting a production quantity of the previous month from a production quantity of the current month. When the coefficient η increases, a fluctuation of a monthly production quantity decreases, and when the coefficient η decreases, a fluctuation of a monthly production quantity increases. Note that the coefficient η may be 0. When the coefficient η becomes 0, a fluctuation of a monthly production quantity is not considered when a predicted inventory quantity is calculated.

The sales quantity display area 309 displays a predicted sales quantity, a predicted upper limit sales quantity, and a predicted lower limit sales quantity for each unit period. In FIG. 7, a predicted sales quantity, a predicted upper limit sales quantity, and a predicted lower limit sales quantity from January 2024 for 6 months are displayed for each month. Note that the sales quantity display area 309 displays not only a predicted sales quantity, a predicted upper limit sales quantity, and a predicted lower limit sales quantity for each unit period but also an actual sales quantity for each unit period included in PSI data. In FIG. 7, an actual sales quantity from April 2023 for 11 months is displayed for each month. Note that the predicted sales quantity and the actual sales quantity may be displayed in an overlapping manner.

The inventory quantity display area 310 displays a predicted inventory quantity for each unit period. In FIG. 7, a predicted inventory quantity from January 2024 for 6 months is displayed for each month. Note that the inventory quantity display area 310 displays not only a predicted inventory quantity for each unit period but also an actual inventory quantity for each unit period included in PSI data. In FIG. 7, an actual inventory quantity from April 2023 for 11 months is displayed for each month. Note that the predicted inventory quantity and the actual inventory quantity may be displayed in an overlapping manner.

The production quantity display area 311 displays a predicted production quantity for each unit period. In FIG. 7, a predicted production quantity from January 2024 for 6 months is displayed for each month. Note that the production quantity display area 311 displays not only a predicted production quantity for each unit period but also an actual production quantity for each unit period included in PSI data. In FIG. 7, an actual production quantity from April 2023 for 11 months is displayed for each month. Note that the predicted production quantity and the actual production quantity may be displayed in an overlapping manner.

Note that a minimum inventory quantity may be set based on an estimation error that is a difference between a predicted sales quantity and a predicted upper limit sales quantity.

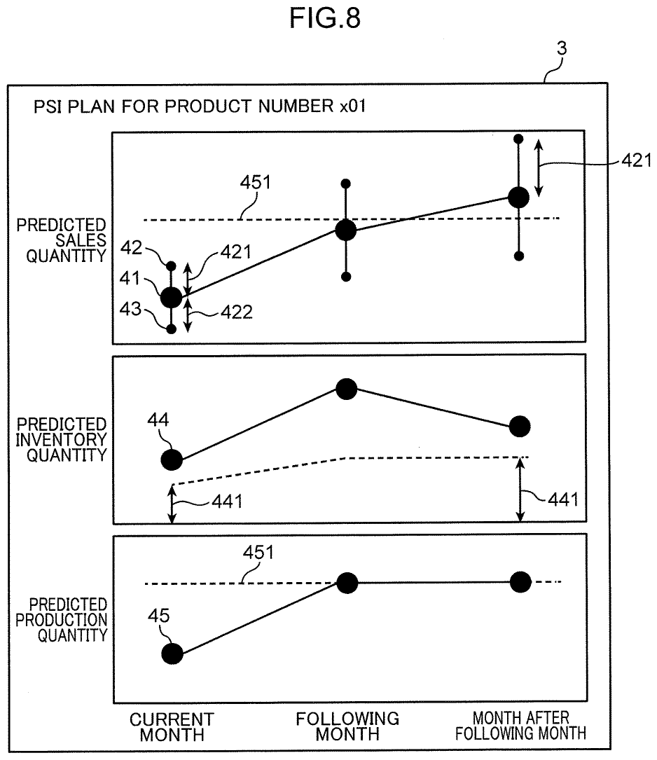

FIG. 8 is a diagram illustrating an example of a user interface screen including a predicted sales quantity, a predicted inventory quantity, and a predicted production quantity for each unit period displayed on the display unit 3 in the present embodiment.

The user interface screen illustrated in FIG. 8 represents a PSI plan of a product number x01. The PSI plan includes a sales plan (predicted sales quantity), an inventory plan (predicted inventory quantity), and a production plan (predicted production quantity). In FIG. 8, the display unit 3 displays, for each month, a predicted sales quantity 41, a predicted upper limit sales quantity 42, a predicted lower limit sales quantity 43, a predicted inventory quantity 44, and a predicted production quantity 45 for three months including the current month, the following month, and the month after the following month. Further, in each month, the predicted sales quantity 41 and the predicted upper limit sales quantity 42 are connected by a straight line, and the predicted sales quantity 41 and the predicted lower limit sales quantity 43 are connected by a straight line.

When obtaining an actual sales quantity of a predetermined product, the predicted sales quantity calculation unit 113 automatically calculates the future predicted sales quantity 41, predicted upper limit sales quantity 42, and predicted lower limit sales quantity 43. The predicted sales quantity 41 is represented by a dot, and the predicted upper limit sales quantity 42 and the predicted lower limit sales quantity 43 are displayed above and below the predicted sales quantity 41. A difference between the predicted sales quantity 41 and the predicted upper limit sales quantity 42 is a positive-side estimation error 421, and a difference between the predicted sales quantity 41 and the predicted lower limit sales quantity 43 is a negative-side estimation error 422. For example, the positive-side estimation error 421 is +10, and the negative-side estimation error 422 is −10. The positive-side estimation error 421 and the negative-side estimation error 422 may be different values.

The positive-side estimation error 421 is a minimum inventory quantity to be maintained (minimum inventory quantity 441) in inventory plan creation. A production plan is created such that the predicted inventory quantity 44 is above the minimum inventory quantity 441. A production plan is created in consideration of a maximum production quantity 451 for one month and an adjustable production unit quantity. The production unit quantity indicates a minimum unit to be produced in one month, for example, 100 units. An inventory plan is created so that the predicted inventory quantity 44 takes as close a value as possible to the minimum inventory quantity 441 and the predicted inventory quantity 44 does not fall below the minimum inventory quantity 441.

The input unit 2 may receive user's adjustment of the positive-side estimation error 421. The user may adjust the positive-side estimation error 421 by operating a mouse through a user interface screen. This makes it possible to reflect an experience of the user on deviation of the predicted sales quantity 41. As a range of the positive-side estimation error 421 increases, the minimum inventory quantity 441 increases in conjunction with the increase.

Conversely, when the minimum inventory quantity 441 is operated, the positive-side estimation error 421 changes. By changing the minimum inventory quantity 441, the user can intuitively understand how much an error of the predicted sales quantity 41 is estimated.

Further, when the predicted sales quantity 41 exceeds the maximum production quantity 451, the predicted production quantity calculation unit 115 increases the predicted production quantity 45 of the previous month. As a result, the predicted inventory quantity 44 of the previous month increases. By this, it is possible to prevent a sales opportunity from being missed. For example, in the example of FIG. 8, the predicted sales quantity 41 of the month after the following month exceeds the maximum production quantity 451. For this reason, the predicted production quantity calculation unit 115 increases the predicted production quantity 45 of the following month in advance.

As the predicted production quantity 45 increases, the predicted inventory quantity 44 increases significantly more than the minimum inventory quantity 441. For this reason, the inventory will be excessive in the following month. However, the predicted inventory quantity 44 will decrease as the predicted sales quantity 41 increases in the month after the following month, and the predicted inventory quantity 44 will return to a quantity substantially equivalent to the minimum inventory quantity 441 again.

Note that the maximum production quantity 451 may be adjusted between products of a plurality of product numbers. For example, when a total of 100 products of two types of product numbers can be made, the user may determine the maximum production quantity 451 of each product. For example, the user may create 50 products for one product and 50 products for the other product, or may create 70 products for one product and 30 products for the other product. The user may drag and move up and down a horizontal line of the maximum production quantity 451 with a mouse on a user interface screen of a PSI plan for each product number of interest. When the maximum production quantity 451 is changed, an inventory plan and a production plan are recalculated accordingly. When the maximum production quantity 451 of one product number changes, the maximum production quantities 451 of all the other product numbers related to one product number change in conjunction with each other, so that the user can search for an optimal balance while looking at each PSI plan.

Note that in each of the above embodiments, each component may be implemented by being configured with dedicated hardware or by execution of a software program suitable for each component. Each component may be implemented by a program execution unit, such as a CPU or a processor, reading and executing a software program recorded on a recording medium such as a hard disk or a semiconductor memory. Further, a program may be executed by another independent computer system by recording and transferring the program on a recording medium or transferring the program via a network.

Some or all functions of the devices according to the embodiments of the present disclosure are implemented as Large Scale Integration (LSI) which is typically an integrated circuit. These may be individually integrated into one chip, or may be integrated into one chip so as to include some or all of these. Further, circuit integration is not limited to LSI, and may be implemented by a dedicated circuit or a general-purpose processor. A Field Programmable Gate Array (FPGA) that can be programmed after manufacturing of LSI or a reconfigurable processor in which connection and setting of circuit cells inside the LSI can be reconfigured may be used.

Further, some or all functions of the device according to the embodiment of the present disclosure may be implemented by a processor such as a CPU executing a program.

Further, the numerical figures used above are all illustrated to specifically describe the present disclosure, and the present disclosure is not limited to the illustrated numerical figures.

Further, order in which steps illustrated in the above flowchart are executed is exemplified for specifically describing the present disclosure, and may be any order other than the above order as long as a similar effect is obtained. Further, some of the above steps may be executed simultaneously (in parallel) with other steps.

The technique according to the present disclosure is useful as a technique for calculating a predicted production quantity for each unit period of a predetermined product and outputting a predicted production quantity for each unit period since it is possible to determine an optimal predicted inventory quantity by using a predicted sales quantity while considering constraints of a production site and automatically determine a predicted production quantity by using a predicted inventory quantity.

1. An information processing method executed by a computer, the method comprising:
acquiring an actual production quantity, an actual sales quantity, an actual inventory quantity, and an actual remaining order quantity for each past unit period of a predetermined product;
acquiring a maximum inventory quantity and a maximum remaining order quantity in a unit period of the predetermined product;
calculating, based on the actual sales quantity, a predicted sales quantity, a predicted upper limit sales quantity allowed in a case where a sales quantity exceeds the predicted sales quantity, and a predicted lower limit sales quantity allowed in a case where the sales quantity falls below the predicted sales quantity, for each future unit period of the predetermined product;
calculating, based on the actual inventory quantity, the actual remaining order quantity, the maximum inventory quantity, the maximum remaining order quantity, the predicted sales quantity, the predicted upper limit sales quantity, and the predicted lower limit sales quantity, a predicted inventory quantity for each future unit period of the predetermined product satisfying a constraint condition that a predicted remaining order quantity does not exceed the maximum remaining order quantity in a case where the predicted sales quantity reaches the predicted upper limit sales quantity, and a predicted inventory quantity does not exceed the maximum inventory quantity in a case where the predicted sales quantity reaches the predicted lower limit sales quantity;
calculating a predicted production quantity for each future unit period of the predetermined product based on the actual inventory quantity, the predicted sales quantity, and the predicted inventory quantity; and
outputting the predicted production quantity for each unit period.

2. The information processing method according to claim 1, wherein the outputting includes outputting the predicted sales quantity, the predicted upper limit sales quantity, the predicted lower limit sales quantity, the predicted inventory quantity, and the predicted production quantity for each unit period.

3. The information processing method according to claim 1, further comprising:
acquiring a maximum production quantity in a unit period of the predetermined product; and
increasing the predicted inventory quantity in a second unit period which is before a first unit period in a case where the predicted sales quantity in the first unit period exceeds the maximum production quantity.

4. The information processing method according to claim 1, wherein calculating the predicted sales quantity, the predicted upper limit sales quantity, and the predicted lower limit sales quantity includes calculating the predicted sales quantity, the predicted upper limit sales quantity, and the predicted lower limit sales quantity by inputting the actual sales quantity to a prediction model created by pre-training, and acquiring the predicted sales quantity, the predicted upper limit sales quantity, and the predicted lower limit sales quantity output from the prediction model.

5. The information processing method according to claim 1, further comprising acquiring calendar information regarding past and future days of the week and holidays, weather information regarding past and future weather, and a past actual sales quantity of a similar product of the predetermined product, wherein
calculating the predicted sales quantity, the predicted upper limit sales quantity, and the predicted lower limit sales quantity includes calculating the predicted sales quantity, the predicted upper limit sales quantity, and the predicted lower limit sales quantity based on the actual sales quantity of the predetermined product, the calendar information, the weather information, and the actual sales quantity of the similar product.

6. The information processing method according to claim 1, wherein
calculating the predicted inventory quantity includes:
calculating the predicted inventory quantity and the predicted remaining order quantity in a unit period t by using the actual inventory quantity and the actual remaining order quantity in a unit period t−1, the predicted sales quantity in the unit period t, and a variable production quantity in the unit period t;
calculating a plurality of combinations of the predicted inventory quantity and the predicted remaining order quantity in the unit period t by changing the production quantity;
selecting, from the plurality of combinations, a combination that satisfies the constraint condition and minimizes a sum of the predicted inventory quantity and the predicted remaining order quantity; and
calculating the predicted inventory quantity of the selected combination as the predicted inventory quantity in the unit period t.

7. The information processing method according to claim 1, wherein calculating the predicted production quantity includes calculating the predicted production quantity by adding the predicted inventory quantity to the predicted sales quantity and subtracting the actual inventory quantity from the added quantity.

8. The information processing method according to claim 1, wherein calculating the predicted inventory quantity includes calculating the predicted inventory quantity of each of a plurality of warehouses in a case where the predetermined product passes through the plurality of warehouses from when the predetermined product is produced to when the predetermined product is sold and moves among the plurality of warehouses for each unit period for which prediction is performed.

9. An information processing device comprising:
a processor; and
a memory including a program that, when executed by the processor, causes the processor to:
acquire an actual production quantity, an actual sales quantity, an actual inventory quantity, and an actual remaining order quantity for each past unit period of a predetermined product;
acquire a maximum inventory quantity and a maximum remaining order quantity in a unit period of the predetermined product;
calculate, based on the actual sales quantity, a predicted sales quantity, a predicted upper limit sales quantity allowed in a case where a sales quantity exceeds the predicted sales quantity, and a predicted lower limit sales quantity allowed in a case where the sales quantity falls below the predicted sales quantity, for each future unit period of the predetermined product;
calculate, based on the actual inventory quantity, the actual remaining order quantity, the maximum inventory quantity, the maximum remaining order quantity, the predicted sales quantity, the predicted upper limit sales quantity, and the predicted lower limit sales quantity, a predicted inventory quantity for each future unit period of the predetermined product satisfying a constraint condition that a predicted remaining order quantity does not exceed the maximum remaining order quantity in a case where the predicted sales quantity reaches the predicted upper limit sales quantity, and a predicted inventory quantity does not exceed the maximum inventory quantity in a case where the predicted sales quantity reaches the predicted lower limit sales quantity;
calculate a predicted production quantity for each future unit period of the predetermined product based on the actual inventory quantity, the predicted sales quantity, and the predicted inventory quantity; and
output the predicted production quantity for each unit period.

10. A non-transitory computer readable recording medium storing an information processing program that causes a computer to function to:
acquire an actual production quantity, an actual sales quantity, an actual inventory quantity, and an actual remaining order quantity for each past unit period of a predetermined product;
acquire a maximum inventory quantity and a maximum remaining order quantity in a unit period of the predetermined product;
calculate, based on the actual sales quantity, a predicted sales quantity, a predicted upper limit sales quantity allowed in a case where a sales quantity exceeds the predicted sales quantity, and a predicted lower limit sales quantity allowed in a case where the sales quantity falls below the predicted sales quantity, for each future unit period of the predetermined product;
calculate, based on the actual inventory quantity, the actual remaining order quantity, the maximum inventory quantity, the maximum remaining order quantity, the predicted sales quantity, the predicted upper limit sales quantity, and the predicted lower limit sales quantity, a predicted inventory quantity for each future unit period of the predetermined product satisfying a constraint condition that a predicted remaining order quantity does not exceed the maximum remaining order quantity in a case where the predicted sales quantity reaches the predicted upper limit sales quantity, and a predicted inventory quantity does not exceed the maximum inventory quantity in a case where the predicted sales quantity reaches the predicted lower limit sales quantity;
calculate a predicted production quantity for each future unit period of the predetermined product based on the actual inventory quantity, the predicted sales quantity, and the predicted inventory quantity; and
output the predicted production quantity for each unit period.
